(19) United States
(12) Patent Application Publication
(10) Pub. No.: US 2024/0127032 A1
(43) Pub. Date: Apr. 18, 2024

(54) Temporal Convolution-Readout for Random Recurrent Neural Networks

(71) Applicant: The Government of the United States of America, as represented by the Secretary of the Navy, Arlington, VA (US)

(72) Inventor: MATTHEW S. EVANUSA, Hyattsville, MD (US)

(21) Appl. No.: 18/381,360

(22) Filed: Oct. 18, 2023

Related U.S. Application Data
(60) Provisional application No. 63/416,997, filed on Oct. 18, 2022.

(51) Int. Cl. G06N 3/044; G06N 3/0464

(52) U.S. Cl. CPC G06N 3/044; G06N 3/0464

(57) ABSTRACT

A neural network apparatus includes a reservoir, which includes a recurrent neural network and receives at least one input temporal sequence. The recurrent neural network includes an initially unlearned input weight matrix and an initially unlearned recurrent weight matrix. The recurrent neural network includes a plurality of neurons. The input weight matrix projects the at least one input temporal sequence from a data space dimension into a dimensionally higher reservoir space dimension. The plurality of neurons receives the projected input temporal sequence and the random recurrent weight matrix and collectively outputs a plurality of reservoir state vectors, which is stacked to form a reservoir state matrix. The neural network apparatus also includes a readout including a one-dimensional, temporal convolutional neural network, which receives the reservoir state matrix from the reservoir. The one-dimensional, temporal convolutional network includes a stack of one-dimensional convolutional blocks, which convolves the reservoir state matrix over time.

### CROSS-REFERENCE TO RELATED APPLICATIONS

This Application claims the benefit of U.S. Provisional Application Ser. No. 63/416,997 filed on 18 Oct. 2022, the entirety of which is incorporated herein by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing NC 211304-US2.

### BACKGROUND OF THE INVENTION

### Field of the Invention

This invention relates in general to artificial intelligence, and more particularly to neural networks.

### Description of the Related Art

With the advent of multilayered/deep feed-forward networks, learning generalizable features for many tasks, such as classification, approximation of the state of the world, for reinforcement learning (“RL”) and data generation, are now possible. However, these multilayered/deep feed-forward networks are designed for and tend to excel at static tasks, such as image classification or generation. Even in cases where the state evolves, such as in RL, the multilayered/deep feed-forward network still learns a static mapping of features to approximate the state. The real world, in contrast, contains exclusively temporal data consisting of the sights, sounds, and video that evolve over time and include daily experiences. Temporal data grows exponentially complex with time, but humans handle this overabundance by keeping a history of the past in the network as memory.

To this end, learning length-invariant, time-varying parametric representations of temporal data that efficiently manage a memory of past events remains an open challenge. A recent line of investigation has been opened into granting neural networks access to an explicit memory location, as in a Turing machine. The mammalian brain is known to store its memory as a combination of dynamical activity as well as synaptic weight changes. This dynamical memory results from maintaining a state of the network, something lacking in conventional feed-forward architectures. To introduce this dynamical state in a neural network, cycles can be created within the network, leading to a Recurrent Neural Network (“RNN”). However, owing to the cycles in the network, training RNNs via backpropagation commonly requires an expensive and tricky unrolling of the network into a synthetic deep feed forward network before training, where the backpropagation is performed—also known as Backpropagation Through Time (“BPTT”). Due to the difficulty of this training, many non-recurrent methods have taken over as the state of the art for temporal data, such as Transformers and feed-forward convolutional autoregressive networks (such as WaveNet and Temporal Convolutional Networks). However, it has been argued that these feed-forward architectures do not generalize well to time series, whose lengths are not encountered during training, have restricted expressivity as compared to their recurrent counterparts, and have issues of efficiency as well as representation learning. Within those of the neuromorphic community who are interested in biologically realistic learning rules, BPTF in its current form is considered non-plausible.

Recently, randomness in neural network parameters and initialization has become an important direction of inquiry into discerning the true effectiveness of deep neural networks. Recent work on biologically-realistic backpropagation shows that randomly chosen feedback matrices are effective at training hidden layers. Proponents of the lottery ticket hypothesis argue that the true work of stochastic gradient descent is finding “winning” randomly initialized subnetworks within larger networks—that the values of the winning sub-trees did not change much even after training. Reliance on over-tuning of architectures in deep learning supports the argument that it is the random initialization of the architecture (and the subsequent fine-tuning of hyperparameters) that creates the best-performing deep networks.

Prior work has looked into using 1-D convolutional filters for time series learning. Hybrid deep learning approaches to reservoir computing have been developed in the past several years to address the inability of “vanilla” reservoir computing to scale up to complex tasks. For example, a combination of a traditional reservoir with multiple sub-reservoirs, as well as a deep artificial neural network with modern regularization techniques, has been shown to outperform state of the art methods on real world data tasks. As another example of prior work, a reservoir with a complex attention and memory mechanism allowed the reservoir access to longer periods of memory. In another example of prior work, untrained kernels were used, as in a convolutional neural network (“CNN”) to train a reservoir to recognize image data, in order to avoid backpropagating the signal through the reservoir. In yet another example of prior work, the reservoir was combined with other kinds of deep learning readouts, for time series classification. A different line of research aimed to stack reservoirs in layers as a multilayer perceptron (“MLP”), which stacks perceptrons in layers, leading to “deep reservoir” computing, and unsupervised ways to train them. In another example of prior work, a multi-timescale convolutional readout learned independent kernels of multi-timescale reservoirs.

### BRIEF SUMMARY OF THE INVENTION

An embodiment of the invention merges ideas from Reservoir Computing with ideas from temporal convolutional deep networks, to show that random recurrent weights are sufficient for temporal learning.

In an embodiment of the invention, rather than enforce multiple timescales in the collected states, includes a deep convolutional readout that learns multiple timescale features. Kernels in the embodiment of the invention also learn to combine activities from multiple reservoirs, which aids in stability.

An embodiment of the invention combines a deep temporal convolutional readout in the time domain with a neuron pool. The deep temporal convolutional readout learns to combine multiple sub-reservoir activity across time as multi-channel kernels. The combination of the readout and the neuron pool learns multi-timescale features.

### BRIEF DESCRIPTION OF THE DRAWINGS

FIG. 1 is a block diagram of a neural network apparatus according to an embodiment of the invention.

FIG. 2 is a block diagram of a recurrent neural network according to an embodiment of the invention.

FIG. 3 is a block diagram of a stack of one-dimensional blocks according to an embodiment of the invention.

FIG. 4 is a block diagram of a one-dimensional block according to an embodiment of the invention.

FIG. 5A is a block diagram of a fully connected layer including a many-to-one classifier according to an embodiment of the invention.

FIG. 5B is a block diagram of a fully connected layer including a one-to-many classifier according to an embodiment of the invention.

FIG. 5C is a block diagram of a fully connected layer including a many-to-many classifier according to an embodiment of the invention.

FIG. 5D is a block diagram of a fully connected layer including a perceptron according to an embodiment of the invention.

FIG. 6A is a block diagram of a non-linear activation layer including a rectified linear unit function according to an embodiment of the invention.

FIG. 6B is a block diagram of a non-linear activation layer including a leaky rectified linear unit function according to an embodiment of the invention.

FIG. 6C is a block diagram of a non-linear activation layer including a Gaussian error linear unit function according to an embodiment of the invention.

FIG. 6D is a block diagram of a non-linear activation layer including a sigmoid function according to an embodiment of the invention.

FIG. 6E is a block diagram of a non-linear activation including a Softmax function according to an embodiment of the invention.

FIG. 6F is a block diagram of a non-linear activation layer including a tanh function according to an embodiment of the invention.

FIG. 7A is a block diagram of a one-dimensional convolutional block including a pooling layer according to an embodiment of the invention.

FIG. 7B is a block diagram of a one-dimensional convolutional block including a downsampling layer according to an embodiment of the invention.

FIG. 7C is a block diagram of a one-dimensional convolutional block including a batch normalization layer according to an embodiment of the invention.

FIG. 8 is a block diagram of a neural network apparatus including a gateway according to an embodiment of the invention.

FIG. 9 is a conceptual, architectural diagram according to an embodiment of the invention.

FIG. 10 is a conceptual diagram of convolutional filters being applied to different neurons in a reservoir according to an embodiment of the invention.

### DETAILED DESCRIPTION OF THE INVENTION

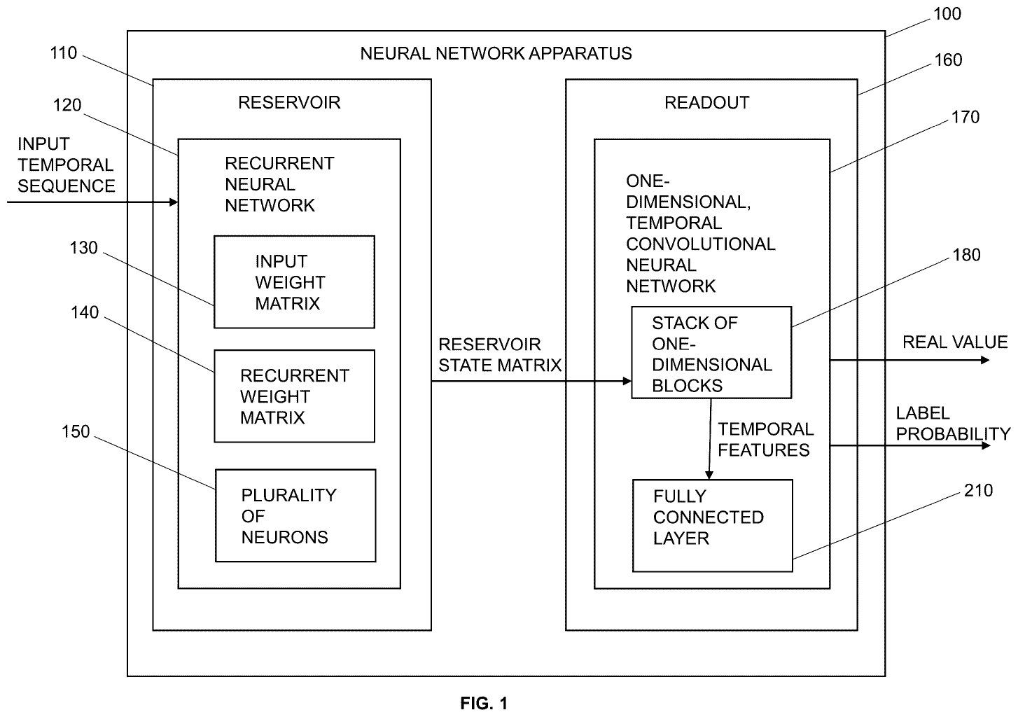

An embodiment of the invention includes a neural network apparatus 100, which is described as follows with reference to FIGS. 1-8. The neural network apparatus 100 includes a reservoir 110. The reservoir 110 includes a recurrent neural network 120 and receives at least one input temporal sequence. For the purpose of this patent application, “input temporal sequence” is a term of art and is defined as a set of input vectors, which are collected in temporal ordering, such that the first vector is the first vector in time, and the last vector is the last vector in time. The input temporal sequence includes a data space dimension. The recurrent neural network 120 includes an initially unlearned input weight matrix 130 and an initially unlearned recurrent weight matrix 140. For the purpose of this patent application, “initially unlearned” is a term of art and characterizes a weight matrix containing weights which are initialized at the start and unlearned; the weights are not learned through training; and the weights are set at specific values at initialization and frozen without further training for the duration. In an embodiment of the invention, the weights have initially random values. In an alternative embodiment of the invention, the weights have initially non-random values, such as when a useful graph for the weights to initialize them is known a priori. In contrast to an initially unlearned weight matrix, a conventional long short-term memory (“LSTM”) network uses gradient descent on the recurrent component during the training. For the purpose of this patent application, a “recurrent weight matrix” is a term of art and is defined as a mathematical matrix of dimension N by N, wherein N is the number of neurons in the reservoir, which mathematical matrix represents the adjacency matrix of connections between each neuron and which allows for information to pass between neurons. The recurrent neural network 120 includes a plurality of neurons 150, which correspond to a plurality of reservoir activities. The initially unlearned input weight matrix 130 projects the at least one input temporal sequence from the data space dimension into a dimensionally higher reservoir space dimension. The number of neurons in the plurality of neurons 150 is equal to a number of dimensions of the reservoir space dimension. The plurality of neurons 150 receives the projected input temporal sequence and the recurrent weight matrix 140. The plurality of neurons 150 collectively outputs a plurality of reservoir state vectors, based on the projected input temporal sequence and the recurrent weight matrix 140. The input weight matrix 130 applies its weights to the input temporal sequence, which pushes the information into the plurality of neurons 150 and adds this projected activity to the prior activity from earlier timesteps. Then, the recurrent weight matrix 140 takes the activity of the plurality of neurons 150 resulting from the application of the input weight matrix 130, and applies its weights to their activity between the plurality of the neurons, resulting in a newer activity of the plurality of neurons. In other words, there are two steps in the activity update, first the data is projected from the temporal sequence into the reservoir activity through the input weights, then the recurrent weights shuffles this new projected activity and the old activity that was already there. The plurality of reservoir state vectors is stacked (for example, by a standard gateway 260, as discussed below) to form a reservoir state matrix.

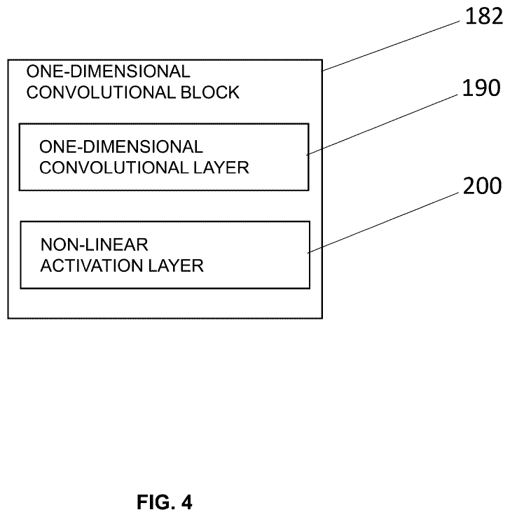

The neural network apparatus 100 also includes a readout 160 comprising a one-dimensional, temporal convolutional neural network 170. Conceptually, the one-dimensional, temporal convolutional neural network 170 performs two tasks: classification and regression. Classification assigns a label probability of a particular label, from a set of known labels, to a given data sample, which the neural network 170 thinks the data best belongs to after training. These label probability outputs are equal in number to the number of labels. Each label probability output is a value between 0 and 1, indicating the probability that the given data sample belongs to that label. The sum of all of the label probabilities must equal 1. Regression is a continuous output, wherein the neural network 170 learns to output, given the input data, a real valued number. This is non-countable and has infinitely many possible outputs. The one-dimensional, temporal convolutional neural network 170 receives the reservoir state matrix from the reservoir 110. The one-dimensional, temporal convolutional network 170 includes a stack of one-dimensional convolutional blocks 180. For the purpose of this patent application, a “stack” is a term of art and is defined as a sequence of layers, in sequential order, where the bottom of the stack is the first layer, which takes input directly from the input signal, and passes the learned weights (either for a convolutional kernel as in a CNN, or fully connected as in the MLP), and each layer following upward takes as input the output from the previous layer. For the purpose of this patent application, a “block” is a term of art and is defined as an organizational element that consists of an ordering of neural network elements of neural network multiplication and summation, activation, and normalization equaling batch normalization or another type of normalization; the block is repeated a given number of times by a programmer or user. For the purpose of this patent application, a “layer” is a term of art and is defined as the core, fundamental processing unit of an artificial neural network, including a mathematical matrix of weights, which projects the input data; the input data consists of either the raw input data for a layer in the bottom of a stack, or the output of a previous layer for middle or output layers; the number of weights corresponds to the size of the input to the layer; each weight is multiplied by the given input and then these multiplications are summed to a single value which is passed through a non-linear activation function, which optionally includes, for example, sigmoid, tanh, rectified linear unit, gaussian linear unit, or other non-linear function, which transforms the summed value in a non-linear fashion to pass to the following layers; the learned weights attempt to learn features that best match the input pattern to the task that the programmer is trying to tell the network to learn. For the regression task, as shown by way of illustration in FIGS. 1 and 4, following a last layer (whether that last layer is the single one-dimensional convolutional layer 190 in an embodiment of the invention or that last layer is the fully connected layer 210 in another embodiment of the invention), there is no non-linear function leading into the output, so that the one-dimensional, temporal convolutional network 170 outputs any real value between negative infinity and positive infinity. For the classification task, as shown by way of illustration in FIG. 1, there is a standard nonlinear activation function used for classification tasks between discrete label probability outputs, each of which is between zero and one and collectively sum to one. An example of this standard non-linear function is a Softmax function, which constrains the one-dimensional, temporal convolutional network 170 to discrete label probability outputs, each of which is between zero and one and collectively sum to one. The stack of one-dimensional convolutional blocks 180 convolves the reservoir state matrix over time, thereby respectively filtering a plurality of temporal features. In the process of performing its classification and regression tasks, the one-dimensional, temporal convolutional network 170 learns the plurality of temporal features that can be seen by peeling off this layer. For the purpose of this patent application, the stack of one-dimensional convolutional blocks is not a multi-dimensional convolutional kernel of a single layer for at least the followings reasons. The reservoir state matrix received from the reservoir effectively makes the by the one-dimensional, temporal convolutional neural network a learned CNN. In an embodiment of the invention, the reservoir state matrix includes kernels that can be likened to small groups of neurons (as opposed to a full layer of neurons, such as might be found in a conventional multilayer perceptron) that the CNN learns.

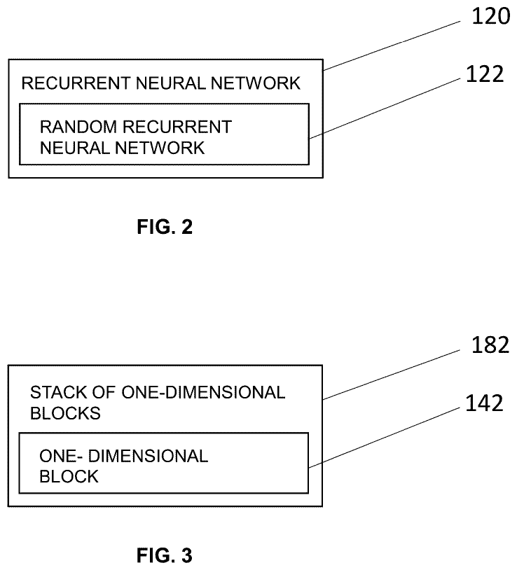

Optionally, the recurrent neural network 120 includes a random, recurrent neural network 122, as shown by way of illustration in FIG. 2. For the purpose of this patent application, “random, recurrent neural network” is a term of art and is defined as recurrent neural network including a recurrent weight matrix, wherein elements of the matrix are drawn from a set random probability distribution. The at least one input temporal sequence includes a plurality of input temporal sequences. The reservoir state matrix is in a reservoir data space. The reservoir data space includes the reservoir space dimension.

Optionally, as shown by way of illustration in FIGS. 3 and 4, each one-dimensional convolutional block 182 of the stack of one-dimensional convolutional blocks 180 includes a standard one-dimensional convolutional layer 190 and a standard non-linear activation layer 200.

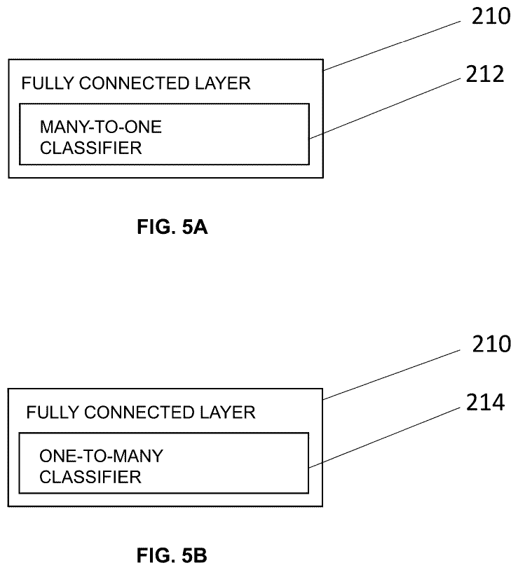

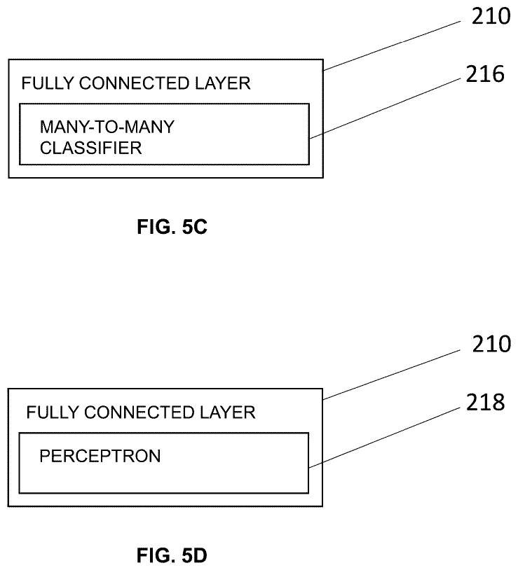

Optionally, the one-dimensional, temporal convolutional network 170 includes a standard fully connected layer 210 connected to the stack of one-dimensional convolutional blocks 180. Optionally, as shown by way of illustration in FIGS. 5A-5D, the fully connected layer 210 includes a standard many-to-one classifier 212, a standard one-to-many classifier 214, a standard many-to-many classifier 216, or a standard perceptron 218.

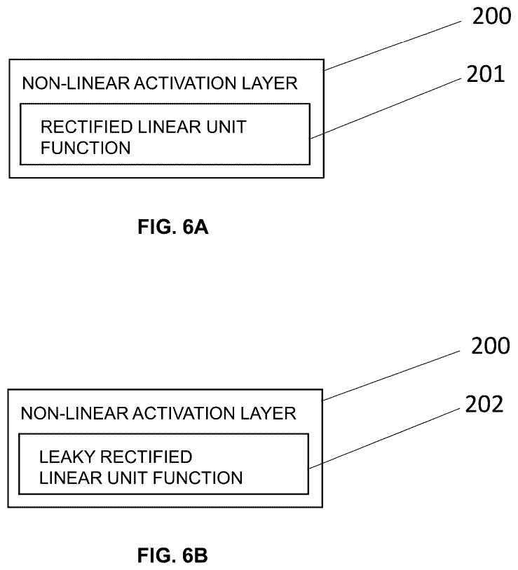

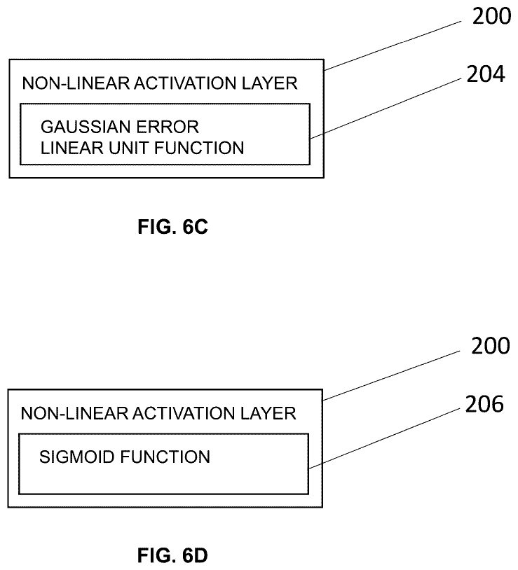

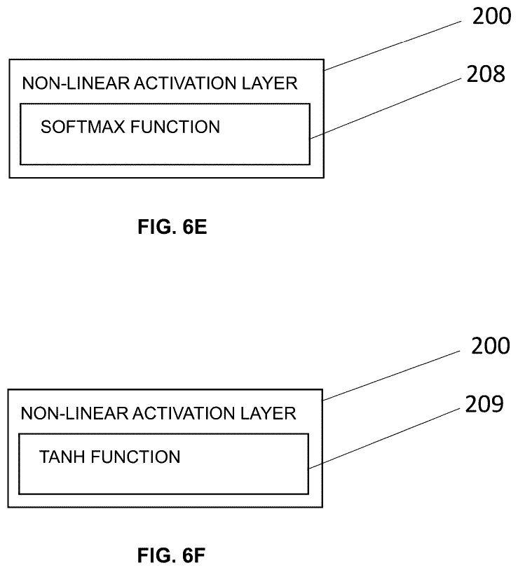

Optionally, as shown by way of illustration in FIGS. 6A-6F, the non-linear activation layer 200 includes a standard Rectified Linear Unit function 201; a standard leaky Rectified Linear Unit function 202; a standard Gaussian Error Linear Unit function 204; a standard Sigmoid function 206; a standard Softmax function 208; or a standard tanh function 209.

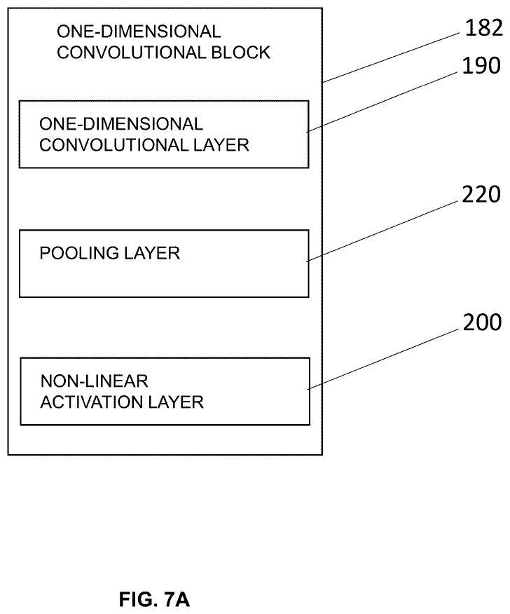

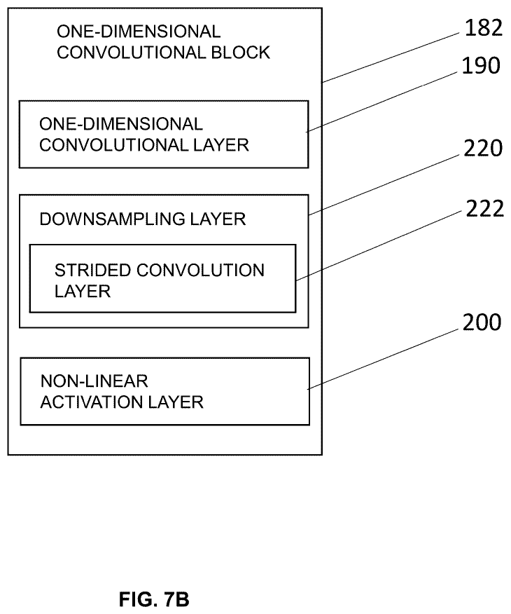

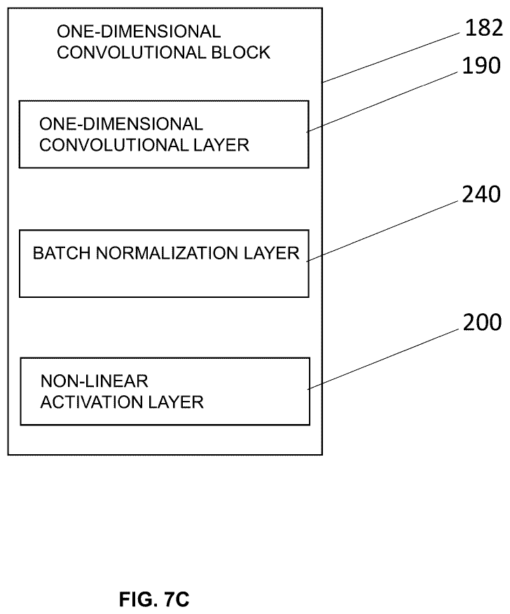

Optionally, as shown by way of illustration in FIGS. 7A-7C the each one-dimensional convolutional block 182 includes a standard pooling layer 220 between the one-dimensional convolutional layer 190 and the non-linear activation layer 200; a standard downsampling layer 230; or a standard batch normalization layer 240 between the one-dimensional convolutional layer and the non-linear activation layer. Optionally, the downsampling layer 230 includes a standard strided convolution layer 232.

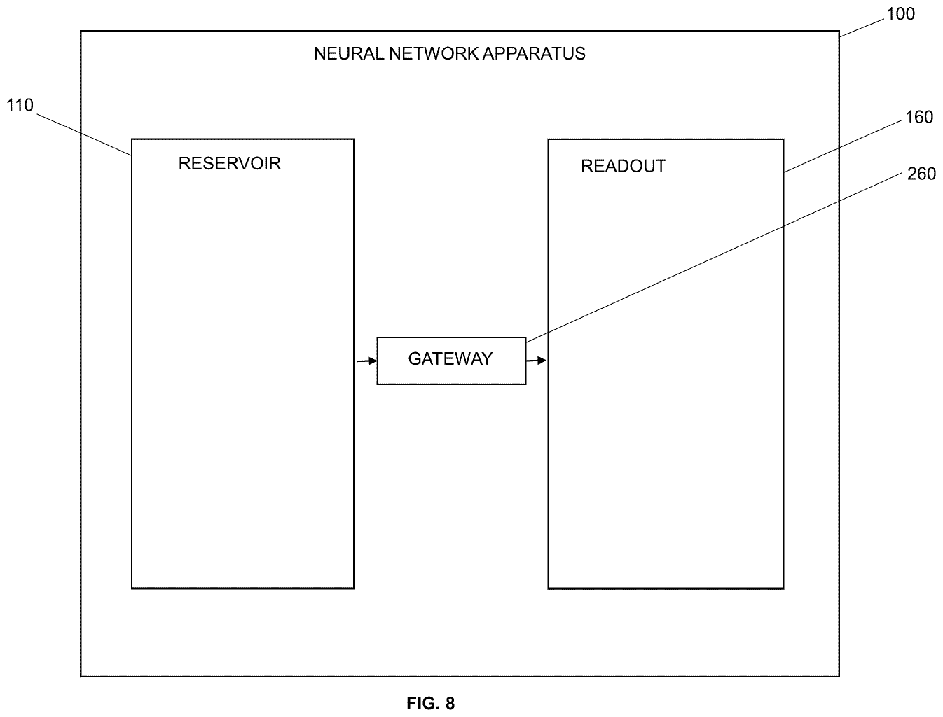

Optionally, as shown by way of illustration in FIG. 8, the neural network apparatus 100 further includes a gateway 250 directly connecting the reservoir 110 to the readout 160. For the purpose of this patent application, “gateway” is a term of art and is defined as a mechanism that directs the output of the reservoir so as to be fed into the readout. Illustrative pseudocode for a gateway 250 according to an embodiment of the invention includes the following:
Collected_matrix=[ ]#Empty set to begin
New_state_vector=run_reservoir(input_data)
Collected_matrix.append(New_state_vector)
Return Collected_matrix

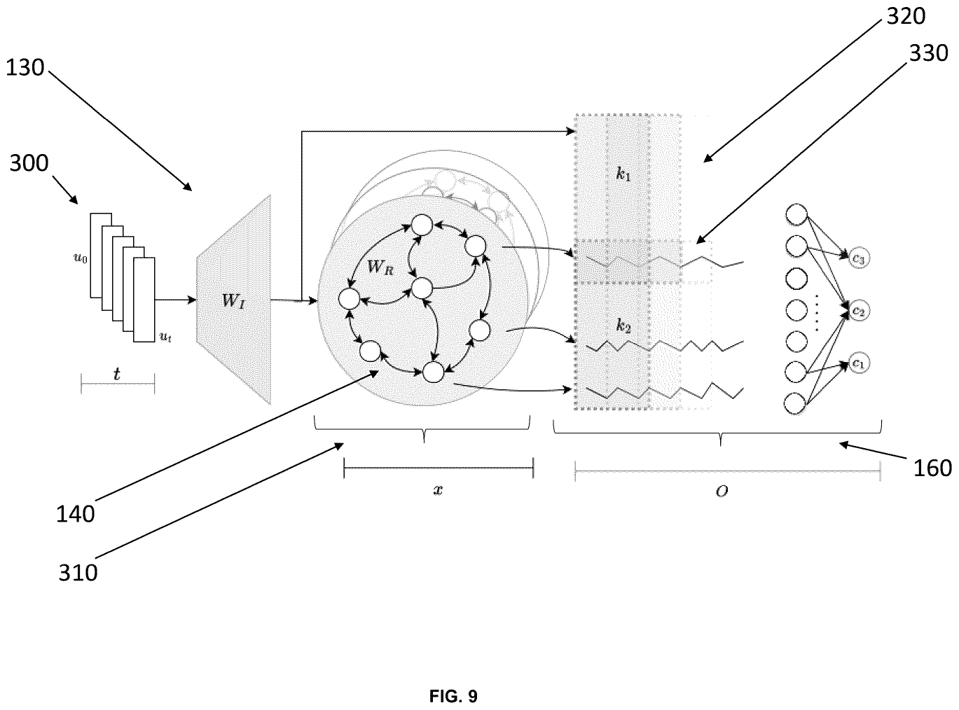

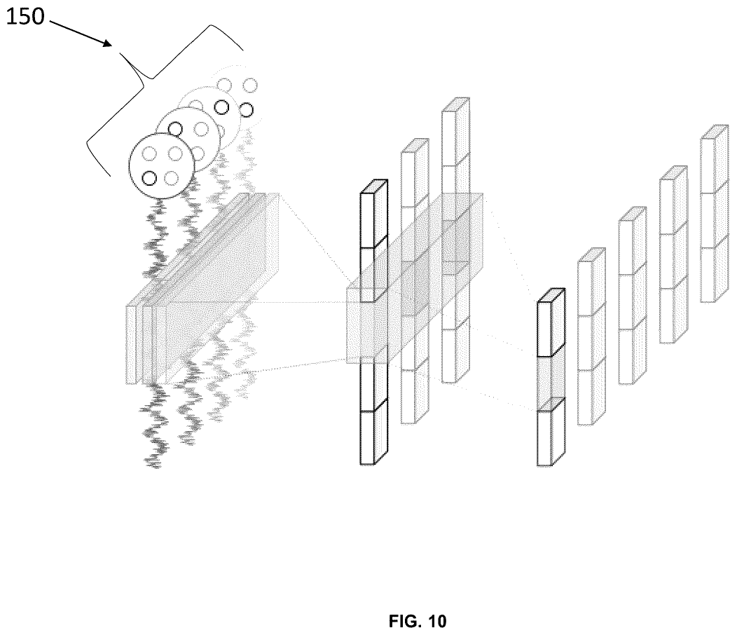

Another embodiment of the invention includes a neural network apparatus 100 and is described as follows with reference to FIGS. 9-10. The neural network apparatus 100 includes a reservoir 110, e.g., an untrained, random recurrent neural network component modeled off of Echo State Network (“ESN”) dynamics, and a deep temporal convolutional readout 160 that learns multi-timescale features with a multi-layered fully connected classifier. The reservoir 110 acts as a temporal kernel machine. The reservoir 110 includes an input weight matrix W₁ 130. The W₁ matrix 130 randomly expands an input temporal sequence 300 in data space into a much higher dimensional temporal reservoir space. For example, this higher dimensional reservoir space is more separable than the initial data space. The deep temporal convolutional readout 160 includes a deep temporal convolutional network 170 that learns multi-timescale features. The reservoir 110 effectively gives the convolutional readout 160 access to a fading memory of the input temporal sequence 300.

Reservoir

The reservoir 110 includes a randomly initialized input weight matrix W₁ 130 and a recurrent weight matrix W_{R} 140, which together determine the state vector of an Echo State Network at any time step. Neurons in the reservoir 110 are represented as the activity vector xₜ 310, which is a weighted linear combination of the activity at the previous time step and the projected activity from the current time step. The activity is calculated as:

xₜ=(1−α)xₜ₋₁+αf(iW₁uₜ+rW_{R}xₜ₋₁) (1)
where xₜ is the N-dimensional vector of the activity states of each reservoir neuron at time t, α is the leak rate, f(·) is a saturating non-linear activation function (here sigmoid), and W₁, W_{R} are the data-to-input weights and reservoir-to-reservoir weights, respectively. The scalars i and r act as input and recurrent weight matrix scaling constants, which reduce or increase the gain on the activity.

Formally, at each time step t, a vector-valued input uₜ∈R^{d} is projected into a higher dimensional reservoir space by the input weight matrix W₁: R^{d}→R^{D} with (d<<D). The W_{R}: R^{D}→R^{D}, also randomly initialized, scales the state vector of the previous time step xₜ₋₁ such that the reservoir keeps a shallow memory of its past. This scaled previous activity is added to the projected input and this current activity is used to update the state vector xₜ as per Eq. 1. The current state activity is a convex combination of the state vector of the previous time step and the current activity for smoother updates. The maximum real eigenvalue of recurrent weight matrix W_{R} 140, denoted the spectral radius, or σ, is normalized to be less than 1; this is a hyperparameter to be set. For example, the hyperparameter is set manually by a programmer or user of an embodiment of the invention. As another example, the hyperparameter is set programmatically by using standard Bayesian hyperoptimization, i.e., using a standard search across hyperparameters in a large run of many different parameters, and then using a standard Bayes process to optimize. This setting of the hyperparameter, i.e., the normalization of the maximum real eigenvalue of recurrent weight matrix W_{R}, ensures the echo state property, or that activity fades, when there is no input.

Each element of the input temporal sequence u₀ . . . u_{T} 300 is fed in one time step at a time to the recurrent neural network (e.g., a randomly weighted recurrent neural network), where T is the maximum length of each series. At each time step (See Eq. 1), the reservoir activity is updated as a combination of the input projected by input weight matrix W₁ 130 and the past time step's activity at t−1 multiplied by the recurrent weight matrix W_{R} 140. The reservoir 110 is instantiated in parallel with other sub-reservoirs. All sub-reservoirs' activity are concatenated before passing into the readout 160. The activity of each reservoir neuron, stored as a vector xₜ at each time step t, is then fed into a temporal convolutional readout 160 (generally referred in FIG. 9 as neural network apparatus output O), along with the input along a “skip connection”, where multiple filters are passed across the series in reservoir space. For example, two kernels k₁ 320 and k₂330 are shifted across the time domain. Finally, per standard convolutional architectures, the resulting feature maps are flattened and passed into, for example, a standard fully-connected multi-layered perceptron for final Softmax classification for class value c. One of ordinary skill in the art will readily appreciate that although only one reservoir has been described above, alternative embodiments of the invention include a multi-reservoir structure, including a plurality of reservoirs as described above.

Finally, in an embodiment of the invention, the final classification or regression is performed by learning an output matrix W_{O}, which maps the state vectors to the corresponding labels yₜ at each time step as in Eq. 1:

yₜ=W_{O}xₜ (2)

For classification or regression tasks, the readout 160 maps all points of one class of input temporal sequence signal to the same label. The class refers to the grouping to which labels are assigned by the user. For example, suppose images of dogs and cats are the input signals; if the user desires a classifier that detects animal type, the class would be “dog or cat,” and there would be a “dog” label and a “cat” label. In another example, if the user desires an alternative classifier that detects how big the animal is in the image, the class would be “big or small”, and there would be a “big” label and a “small” label. The weights of output matrix W_{O} of the readout layer are trained with a standard loss function for the different downstream tasks, namely, the classification task and the regression task. An illustrative loss function for the regression task is the standard Mean Squared Error (“MSE”) function. An illustrative loss function for the classification task is the standard Cross Entropy function. In an embodiment of the invention, output matrix W_{O} is a temporal convolutional readout, which is described below and which is shown conceptually in FIG. 10.

The result of the convolution performed by the convolutional filters applied to different neurons in the reservoir 110 is passed to a fully connected readout 160. The neuron shading depicts that the vertical signal output corresponds to a single neuron. All of the neurons collective outputs are passed over by multi-channeled 1-dimensional convolutional kernels, which output a vector feature map. The middle and left bars represent the second and third layers, respectively, of the CNN readout 160—for visualization purposes, as the number of layers can be changed—and the shading levels correspond to the value resulting from a particular convolution channel.

In an embodiment of the invention, the reservoir 110, for example, includes a plurality of parallel sub-reservoirs. Instead of one large reservoir of dimension D, the input temporal sequence 300 is passed to multiple sub-reservoirs M with each reservoir of dimension H such that D=M*H, which are inter-connected amongst themselves but not with other sub-reservoirs. Mathematically, this is equivalent to one large reservoir with zeroes everywhere except for small blocks of weights around the diagonal. Using parallel sub-reservoirs is more computationally stable for the readout mechanism than a one large reservoir, and produces more consistent and accurate results, especially for the convolutional readout. Whereas concatenating the sub-reservoirs for a fully connected readout forces the readout to learn alternating combinations of sub-reservoirs, parallel sub-reservoirs according to an embodiment of the invention have no effect on the convolution operation. This is because the convolutions are still applied across time, and the readout learns to map neurons from sub-reservoirs in non-linear combinations across time. The parallel sub-reservoirs are analogous to the multiple heads in the transformer attention, or the multiple channels in a CNN architecture. Increasing the number of initializations in parallel increases the feature space that can be searched. FIG. 10 depicts the interaction between the sub-reservoirs and the convolutional readout.

Temporal Convolutional Readout

As mentioned above, the neural network apparatus 100 includes a temporal convolutional readout 160, also known as a Time Delay Neural Network, or Temporal Convolutional Neural Network, as the readout for a recurrent neural network 110 (e.g., a random RNN). In an embodiment of the invention, the temporal convolutional readout 160 does not include causal convolutions. This readout 160 includes filters, which convolve over the state vectors of the reservoir at different time steps to extract temporal features from the data. The different reservoir state vectors x are stacked to form the time series data matrix X, which is convolved with the temporal convolutional filters across time. A filter k={k¹, k², . . . , k^{D}} such that kⁱ slides over the activity across time of neuron xⁱ according to the equation:

D

f(X)[t]=(X*k)[t]=^{X}(xⁱ*kⁱ)[t]

i=1

m=n

(xⁱ*kⁱ)[t]=^{X}xⁱₜ−ₘkⁱ[m]m=−n (3)

As for deep CNN architectures, such multiple 1d-convolution layers are stacked to extract hierarchical temporal features from the data for final classification, according to the equation:

fⁱ(X)=σ⊙(fⁱ(X)[0],fⁱ(X)[1], . . . fⁱ(X)[T])

y=W_{O}(f¹∘ . . . ∘f²∘fⁱ(X)) (4)

where T is the number of time steps in an example of the time series, σ is the activation which is applied point-wise (⊙) to the output of a convolutional layer and n if the total number of 1-d convolution layers. Each convolutional layer fⁱ consists of multiple filters, which convolve over the input to the layer in parallel.

Each convolutional layer convolving over the input to the layer in parallel yields nonlinear combinations of the responses of individual neurons as a function of time in a much more compact way compared to all-to-all connections as in a multi-layered Perceptron. One way to view this interaction is that the readout is learning nonlinear filters of the response of the recurrent component; in this way the reservoir can be seen as acting as a random temporal kernel. Due to the way convolution operates in one dimension, each channel of filters actually learns a combination of the responses of each neuron, which gives the readout more computational flexibility than being forced to learn a filter for each neuron. The convolutional kernels are stacked in layers, allowing the readout to extract hierarchical features across time. In addition, the kernels share weights, facilitating the network to learn shift-invariant features. For example, the kernel weights are trained using a standard backpropagation algorithm. In alternative embodiments of the invention, causal and/or dilated convolutions are employed on the kernels. The feature maps resulting from the convolutions are fed into a multi-layered feed forward network for final classification. In an embodiment of the invention, the readout is trained with backpropagation. However, in an alternative embodiment of the invention, for a future biologically-adjacent nonlinear network training rule, such as Feedback Alignment, the backpropagation is performed in a feed-forward manner, rather than through time. In an alternative embodiment of the invention, standard residual convolutional connections (e.g., a standard one-dimensional ResNet) are substituted for the above-mentioned stacked convolutional layers.

Optionally, one or more portions of the invention operate in a standard computing operating environment, for example, a desktop computer, a laptop computer, a mobile computer, a server computer, and the like. Although the invention is described in the general context of program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, autonomous embedded computers, and the like. The invention may also be practiced in distributed computing environments where tasks are performed by remote processing devices that are linked through a communications network. In a distributed computing environment, program modules may be located in both local and remote memory storage devices.

An illustrative operating environment for embodiments of the invention is described as follows. A computer comprises a general purpose desktop, laptop, handheld, mobile or other type of computer (computing device) capable of executing one or more application programs. The computer includes at least one central processing unit (“CPU”), a system memory, including a random access memory (“RAM”) and a read-only memory (“ROM”), and a system bus that couples the memory to the CPU. A basic input/output system containing the basic routines that help to transfer information between elements within the computer, such as during startup, is stored in the ROM. The computer further includes a mass storage device for storing an operating system, application programs, and other program modules.

The mass storage device is connected to the CPU through a mass storage controller connected to the bus. The mass storage device and its associated computer-readable media provide non-volatile storage for the computer. Although the description of computer-readable media contained herein refers to a mass storage device, such as a hard disk or CD-ROM drive, it should be appreciated by those skilled in the art that computer-readable media can be any available media that can be accessed or utilized by the computer.

By way of example, and not limitation, computer-readable media comprise computer storage media and communication media. Computer storage media includes non-transitory, non-volatile, removable and non-removable media implemented in any method or technology for storage of information such as computer-readable instructions, data structures, program modules or other data. Such non-transitory computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other tangible non-transitory medium which can be used to store the desired information and which can be accessed by the computer.

According to various embodiments of the invention, the computer may operate in a networked environment using logical connections to remote computers through a network, such as a local network, the Internet, etc. for example. The computer may connect to the network through a network interface unit connected to the bus. It should be appreciated that the network interface unit may also be utilized to connect to other types of networks and remote computing systems.

The computer may also include an input/output controller for receiving and processing input from a number of other devices, including a keyboard, mouse, etc. Similarly, an input/output controller may provide output to a display screen, a printer, or other type of output device.

As mentioned briefly above, a number of program modules and data files may be stored in the mass storage device and RAM of the computer, including an operating system suitable for controlling the operation of a networked personal computer. The mass storage device and RAM may also store one or more program modules. In particular, the mass storage device and the RAM may store application programs, such as a software application, for example, a word processing application, a spreadsheet application, a slide presentation application, a database application, etc.

It should be appreciated that various embodiments of the present invention may be implemented as a sequence of computer-implemented acts or program modules running on a computing system and/or as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as described herein.

Although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of ±10% of that stated.

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed as new and desired to be protected by Letters Patent of the United States is:

1. An apparatus comprising:
a reservoir comprising a recurrent neural network and receiving at least one input temporal sequence, the at least one input temporal sequence comprising a data space dimension, said recurrent neural network comprising an initially unlearned input weight matrix and an initially unlearned recurrent weight matrix, said recurrent neural network comprising a plurality of neurons corresponding to a plurality of reservoir activities, the initially unlearned input weight matrix projecting the at least one input temporal sequence from the data space dimension into a dimensionally higher reservoir space dimension, a number of neurons in the plurality of neurons being equal to a number of dimensions of the reservoir space dimension, said plurality of neurons receiving the projected input temporal sequence and the random recurrent weight matrix, said plurality of neurons collectively outputting a plurality of reservoir state vectors, the plurality of reservoir state vectors being stacked to form a reservoir state matrix; and
a readout comprising a one-dimensional, temporal convolutional neural network, said one-dimensional, temporal convolutional neural network receiving the reservoir state matrix from said reservoir, said one-dimensional, temporal convolutional network comprising a stack of one-dimensional convolutional blocks, said stack of one-dimensional convolutional blocks convolving the reservoir state matrix over time, thereby respectively filtering a plurality of temporal features.

2. The apparatus according to claim 1, wherein said recurrent neural network comprises a random, recurrent neural network,
wherein said at least one input temporal sequence comprises a plurality of input temporal sequences,
wherein the reservoir state matrix is in a reservoir data space, the reservoir data space comprising the reservoir space dimension.

3. The apparatus according to claim 1, wherein each one-dimensional convolutional block of said stack of one-dimensional convolutional blocks comprises a one-dimensional convolutional layer and a non-linear activation layer.

4. The apparatus according to claim 1, wherein said one-dimensional, temporal convolutional network comprises:
a fully connected layer connected to said stack of one-dimensional convolutional blocks.

5. The apparatus according to claim 4, wherein said fully connected layer comprises one of a many-to-one classifier, a one-to-many classifier, and a many-to-many classifier.

6. The apparatus according to claim 4, wherein said fully connected layer comprises a perceptron.

7. The apparatus according to claim 1, wherein said non-linear activation layer comprises one of:
a Rectified Linear Unit function;
a leaky Rectified Linear Unit function;
a Gaussian Error Linear Unit function;
a Sigmoid function;
a Softmax function; and
a tanh function;

8. The apparatus according to claim 1, wherein said each one-dimensional convolutional block comprises one of:
a pooling layer between said one-dimensional convolutional layer and said non-linear activation layer,
a downsampling layer; and
a batch normalization layer between said one-dimensional convolutional layer and said non-linear activation layer.

9. The apparatus according to claim 8, wherein said downsampling layer comprises a strided convolution layer.

10. The apparatus according to claim 1, further comprising:
a gateway directly connecting said reservoir to said readout.
